(19) United States
(12) Patent Application Publication
(10) Pub. No.: US 2025/0253601 A1
(43) Pub. Date: Aug. 7, 2025

(54) TERMINAL ASSEMBLY, FEMALE SOCKET MECHANISM, MALE PLUG MECHANISM AND CIRCULAR CONNECTOR USING SAME

(71) Applicant: PALCONN TECHNOLOGY CO., LTD, Shenzhen (CN)

(72) Inventors: Liangjun Luo, Shenzhen (CN); Zelin Sun, Shenzhen (CN)

(21) Appl. No.: 18/635,060

(22) Filed: Apr. 15, 2024

(30) Foreign Application Priority Data
Feb. 6, 2024 (CN) 202410171103.8
Feb. 6, 2024 (CN) 202410171104.2
Feb. 6, 2024 (CN) 202410171106.1

(51) Int. Cl. H01R 24/86; H01R 13/05; H01R 13/10; H01R 13/506; H01R 13/512; H01R 13/627

(52) U.S. Cl. CPC H01R 24/86; H01R 13/052; H01R 13/10; H01R 13/506; H01R 13/512; H01R 13/6277

(57) ABSTRACT

The present invention discloses a terminal assembly, a female socket mechanism, a male plug mechanism and a circular connector using same. The terminal assembly comprises an insulator and terminal bodies arranged on an outer circumferential wall of the insulator. When the present invention is used, by assembling the terminal bodies on the outer circumferential wall of the insulator, assembly cost is reduced, and at the same time, assembly space of the terminal bodies on the insulator is expanded, so that the terminal assembly has a smaller size and a wider application range.

### CROSS REFERENCE TO RELATED APPLICATIONS

The present application claims the benefit of Chinese Patent Application Nos. 202410171106.1, 202410171104.2 and 202410171103.8 filed on Feb. 6, 2024. All the above are hereby incorporated by reference in their entirety.

### FIELD OF INVENTION

The present invention belongs to the technical field of connectors, and particularly relates to a terminal assembly, a female socket mechanism, a male plug mechanism and a circular connector using same.

### BACKGROUND ART OF THE INVENTION

Circular connectors are a kind of important connectors, and are named because of having cylindrical basic structures and circular inserting surfaces. Circular connectors are used for providing connection and transmission of power supply, signals and data for various equipment and systems, and are widely used in sectors and application fields such as military, aviation, medical care and industry. For terminal assemblies used in existing circular connectors on the market, arrays of cylindrical terminal bodies are inserted into an insulator, and the cylindrical terminal bodies can only be prepared by a turning process, so that manufacturing cost is high; during assembly, assembly space on the insulator is small, and the terminal bodies are limited by each other, so that assembly difficulty is increased; if mechanical assembly is adopted, it is easy to scratch surfaces of the terminal bodies and cause a great loss; if manual assembly is adopted, it will lead to low production efficiency, thus resulting in high assembly cost of the terminal bodies and high price of the circular connectors; in addition, due to limitation of the turning process, a size of a terminal body prepared by turning is large, so that sizes of terminal assemblies and circular connectors are large, and use thereof is limited.

### DISCLOSURE OF THE INVENTION

The purpose of the present invention is to provide a terminal assembly, a female socket mechanism, a male plug mechanism and a circular connector using same, which solves the problems of high production and assembly cost, large size and limited use of existing terminal assemblies.

To achieve the above purpose, a first technical solution of the present invention is realized as follows: a terminal assembly, comprising an insulator and terminal bodies arranged on an outer circumferential wall of the insulator.

Further, limiting grooves compatible with the terminal bodies are formed in the outer circumferential wall of the insulator, and the terminal bodies are located in the limiting grooves.

Further, an extension direction of the terminal bodies is parallel to an axis of the insulator.

Further, the terminal assembly also comprises a coaxial assembly, and the coaxial assembly is arranged in the insulator along the axis of the insulator.

Further, one end of each terminal body is flat, or one end of each terminal body is extended along a radial direction of the insulator to form a bending part, or a bulge part is formed on one end of each terminal body.

Further, at least two terminal bodies are used, and the at least two terminal bodies are arranged on the outer circumferential wall of the insulator at intervals.

A second technical solution of the present invention is realized as follows: a female socket mechanism, comprising a female socket shell assembly and the terminal assembly, wherein the terminal assembly is arranged in the female socket shell assembly.

Further, the female socket shell assembly comprises a female socket shell and a fixing member arranged in the female socket shell, and the terminal assembly is connected with the female socket shell through the fixing member.

Further, one end of the fixing member is extended into the female socket shell and is connected with the terminal assembly, a bending part is formed on the other end, the bending part is connected with one end of the female socket shell, and the end of the female socket shell is stuck in the bending part.

Further, the bending part is U-shaped and is stuck with the end of the female socket shell by interference fit, and the bending part is connected or bonded with the female socket shell by ultrasonic waves.

Further, the fixing member is connected with the female socket shell in a buckle form; a clamping block is arranged on the fixing member, and a clamping slot matched with the clamping block is formed in the female socket shell; or a clamping block is arranged on the female socket shell, and a clamping slot matched with the clamping block is formed in the fixing member.

Further, the female socket shell is also provided with a protective member;

The protective member comprises an outer protective ring and an inner protective ring, the outer protective ring is arranged on an outer wall of the female socket shell, and the inner protective ring is arranged on an inner wall of the female socket shell.

Further, the outer wall of the female socket shell is in threaded connection with a nut.

A third technical solution of the present invention is realized as follows: a male plug mechanism, comprising a male plug shell assembly and the terminal assembly, wherein the terminal assembly is arranged in the male plug shell assembly.

Further, the male plug shell assembly comprises an outer shell and an inner shell, the outer shell is sheathed on the inner shell, and the terminal assembly is arranged in the inner shell.

Further, the inner shell is provided with a guide member, and the outer shell has a limiting hole matched with the guide member.

Further, an inner wall of the outer shell is provided with a limiting member, and an outer wall of the inner shell has a limiting groove matched with the limiting member.

Further, the male plug mechanism also comprises a cable positioning assembly, one end of the cable positioning assembly is located in the outer shell and connected with the inner shell.

Further, the cable positioning assembly comprises a tail cover and a wire clamp arranged in the tail cover, one end of the tail cover is extended to the outside of the outer shell, the wire clamp is tightened toward an axial direction of the male plug mechanism by an inner wall thereof, and the other end of the tail cover is connected with the inner shell.

A fourth technical solution of the present invention is realized as follows: a circular connector, comprising the female socket mechanism and the male plug mechanism, wherein the female socket mechanism is compatible with the male plug mechanism.

Further, when one end of each terminal body in the female socket mechanism is flat, the end is matched and connected with the bending part or the bulge part of the end of each terminal body in the male plug mechanism; when one end of each terminal body in the female socket mechanism is a bending part or a bulge part, the end is matched and connected with a flat end of each terminal body in the male plug mechanism;

Further, a positioning groove is formed in the female socket shell assembly, and a positioning member matched with the positioning groove is arranged on the male plug shell assembly.

Further, a guide groove matched with the guide member is formed in the female socket shell assembly.

Compared with the prior art, the present invention has the following beneficial effects: in the terminal assembly of the present invention, by assembling the terminal bodies on the outer circumferential wall of the insulator, the defect of limited installation space caused when the arrays of the cylindrical terminal bodies are inserted into the insulator in the prior art are effectively avoided, and transformation to mechanical installation is realized without causing any loss of the terminal bodies, so that an assembly process is simplified and the assembly cost is reduced; at the same time, as space of the outer circumferential wall of the insulator is large, assembly space of the terminal bodies is relatively increased, and a size of the terminal assembly is reduced and an application range of the terminal assembly is increased when a same number of terminal bodies are assembled.

### DESCRIPTION OF THE DRAWINGS

FIG. 1 is a three-dimensional structural schematic diagram of an existing terminal assembly;

FIG. 2 is a three-dimensional structural schematic diagram of a terminal assembly provided by embodiment 1 of the present invention;

FIG. 3 is a three-dimensional structural schematic diagram of a terminal body in a terminal assembly provided by embodiment 1 of the present invention;

FIG. 4 is a three-dimensional structural schematic diagram of a female socket mechanism provided by embodiment 2 of the present invention;

FIG. 5 is an exploded view of a female socket mechanism provided by embodiment 2 of the present invention;

FIG. 6 is a three-dimensional structural schematic diagram of another female socket mechanism provided by embodiment 2 of the present invention;

FIG. 7 is a sectional view of another female socket mechanism provided by embodiment 2 of the present invention;

FIG. 8 is a three-dimensional structural schematic diagram of a male plug mechanism provided by embodiment 3 of the present invention;

FIG. 9 is an exploded view of a male plug mechanism provided by embodiment 3 of the present invention;

FIG. 10 is a sectional view of a male plug mechanism provided by embodiment 3 of the present invention;

FIG. 11 is a three-dimensional structural schematic diagram of a circular connector provided by embodiment 4 of the present invention;

FIG. 12 is a sectional view of a circular connector provided by embodiment 4 of the present invention.

In the figures, 1—terminal assembly, 11—insulator, 12—terminal body, 121—bending part, 122—bulge part, 13—limiting groove, 14—coaxial assembly;
2—female socket shell assembly, 21—female socket shell, 211—clamping slot, 212—nut, 213—guide groove, 22—fixing member, 221—bending part, 222—clamping block, 23—positioning groove;
3—male plug shell assembly, 31—outer shell, 311—limiting hole, 312—limiting member, 32—inner shell, 321—guide member, 322—limiting groove, 33—positioning member;
4—protective member, 41—outer protective ring, 42—inner protective ring;
5—cable positioning assembly, 51—wire clamp, 52—tail cover.

### DETAILED DESCRIPTION OF THE INVENTION

To make the purpose, the technical solution and the advantages of the present invention more clear, the present invention will be further described below in detail in combination with specific embodiments. It should be understood that the specific embodiment described herein is only used for explaining the present invention, not used for limiting the present invention.

It should be clear in the description of the present invention that terms such as “perpendicular”, “transverse”, “longitudinal”, “front”, “rear”, “left”, “right”, “upper”, “lower”, “horizontal”, etc. indicate direction or position relationships shown based on the drawings, and are only intended to facilitate the description of the present invention rather than to mean that the indicated device or element must have a specific direction or position, and therefore, shall not be understood as a limitation to the present invention. It should be noted in the description of the present invention that, unless otherwise specifically regulated and defined, terms such as “installation,” “connected,” and “connecting” shall be understood in broad sense, and for example, may refer to fixed connection or detachable connection or integral connection, and may refer to direct connection or indirect connection through an intermediate medium. For those ordinary skilled in the art, the specific meanings of the above terms in the present invention may be understood according to specific conditions.

### Embodiment 1

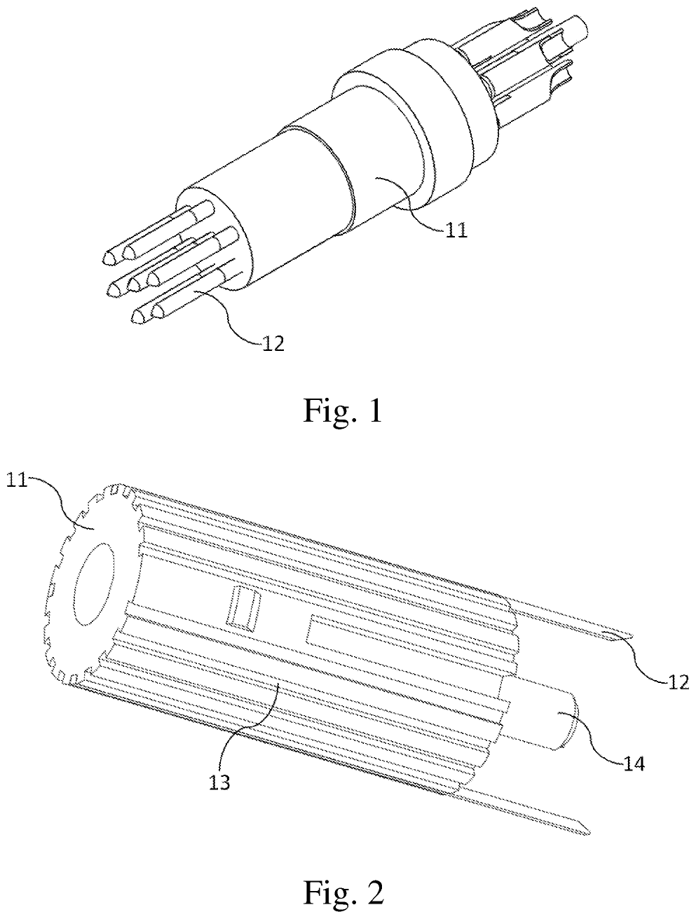

As shown in FIG. 1, during production of an existing terminal assembly 1, cylindrical terminal bodies 12 are prepared one by one by a turning process; the process leads to high production cost and low production efficiency of the terminal bodies 12, and a size of the terminal bodies 12 is large due to limitation of the turning process. Arrays of the terminal bodies 12 are inserted into an insulator 11 during assembly; during this process, if mechanical operation is adopted, it is easy to scratch the terminal bodies 12 and cause a great loss; if manual operation is adopted, it will lead to low assembly efficiency; in addition, as the size of the terminal bodies 12 is large, the overall size of the insulator 11 and the terminal assembly 1 is large, and the application range is limited.

At the same time, when the terminal bodies 12 are used, wires need to be welded on one end of each terminal body 12; as the terminal bodies 12 are assembled densely, welding operation need to be completed manually due to space limitation, and the assembly efficiency is further reduced.

A terminal assembly provided in the embodiment, with a structure shown in FIG. 2, comprising the insulator 11 and the terminal bodies 12 arranged on an outer circumferential wall of the insulator 11;

Based on the above structure, in the terminal assembly 1, by assembling the terminal bodies 12 on the outer circumferential wall of the insulator 11, the defect of limited installation space caused when the arrays of the cylindrical terminal bodies 12 are inserted into the insulator 11 in the prior art are effectively avoided, and transformation to mechanical installation is realized without causing any loss of the terminal bodies 12, so that an assembly process is simplified and the assembly cost is reduced; at the same time, as space of the outer circumferential wall of the insulator 11 is large, assembly space of the terminal bodies 12 is relatively increased, so that a size of the terminal assembly 1 is smaller than that of a conventional terminal assembly and an application range of the terminal assembly 1 is wider when a same number of terminal bodies 12 are assembled.

In some embodiments of the present application, limiting grooves 13 compatible with the terminal bodies 12 are formed in the outer circumferential wall of the insulator 11, the terminal bodies 12 are located in the limiting grooves 13, and connection stability of the terminal bodies 12 and the insulator 11 is increased by the limiting grooves 13.

In some embodiments of the present application, the terminal assembly 1 also comprises a coaxial assembly 14, and the coaxial assembly 14 is arranged in the insulator 11; specifically, the coaxial assembly 14 is arranged along an axis of the insulator 11.

Number of the coaxial assembly 14 can be determined according to users' using requirements, and can be optionally set as one or two.

In the embodiment, the coaxial assembly 14 is arranged to ensure that when the terminal assembly 1 is used in radio frequency equipment, the terminal assembly 1 has a sufficient impedance matched with the radio frequency equipment, and the use effect is good.

In some embodiments of the present application, the terminal bodies 12 have a flat strip structure; the problem that the existing cylindrical terminal bodies can only be prepared by a turning process is avoided, the terminal bodies 12 of the present invention are prepared by a stamping process, the production cost is reduced, the size of the terminal bodies 12 is not limited by the preparation process, and the size of the terminal bodies 12 can be further reduced, thus the overall size of the terminal assembly 1 can be reduced, and the application range thereof can be expanded.

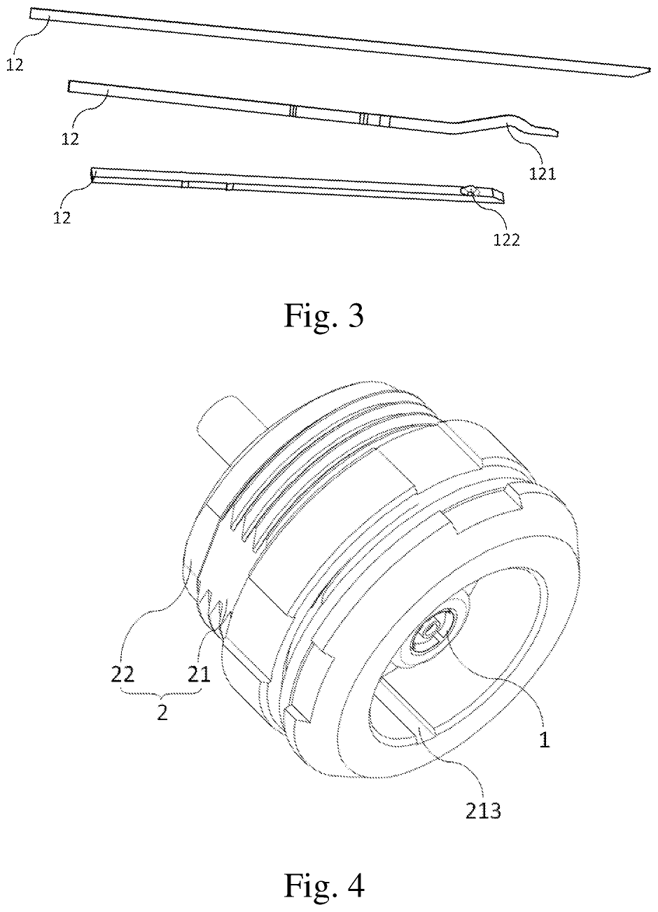

As shown in FIG. 3, in some embodiments of the present application, one end of each terminal body 12 is flat, or one end of each terminal body 12 is extended along a radial direction of the insulator 11 to form a bending part 121, or a bulge part 122 is formed on one end of each terminal body 12; in use, each terminal body 12 with the flat end is arranged in the female socket mechanism, and each terminal body 12 with the bending part 121 or the bulge part 122 is arranged in the male plug mechanism; or each terminal body 12 with the flat end is arranged in the male plug mechanism, and each terminal body 12 with the bending part 121 or the bulge part 122 is arranged in the female socket mechanism.

After the male plug mechanism is inserted into the female socket mechanism, the flat end of one terminal body 12 is in interference fit with the bending part 121 and the bulge part 122 of another terminal body 12 to ensure the connection stability.

In some embodiments of the present application, at least two terminal bodies 12 are used, the at least two terminal bodies 12 are arranged on the outer circumferential wall of the insulator 11 at intervals, and an extension direction of the terminal bodies 12 is parallel to the axis of the insulator 11.

In the embodiment, the assembly space of the terminal bodies 12 is on the outer circumferential wall of the insulator 11, which has a large range. Therefore, the number of the terminal bodies 12 assembled can be set according to users' requirements, and is not limited by the assembly space and assembly process.

A preparation process of the terminal assembly provided by the embodiment is specifically as follows:

An appropriate size of plate is cut, the terminal bodies 12 are prepared on one side of the plate by a stamping process, and a plurality of terminal bodies 12 are connected by the other side of the plate; during assembly, the insulator 11 is rotated while the plate is moved, thus to drive the terminal bodies 12 to move, and the terminal bodies 12 are assembled in the limiting grooves 13 in the outer circumferential wall of the insulator 11. The terminal bodies 12 in the present invention are prepared by the stamping process, the preparation cost is reduced, and the size of the terminal bodies 12 can be reduced. By assembling the terminal bodies 12 on the outer circumferential wall of the insulator 11, the assembly space of the terminal bodies 12 can be increased, the number of the terminal bodies 12 assembled is not limited, the problem of small operation space caused when the arrays of the plurality of terminal bodies 12 are inserted into the insulator 11 can be avoided, and the terminal bodies 12 and the wires can be welded by automatic welding. At the same time, the present invention also uses the above process to mechanically assemble the terminal bodies 12 and the insulator 11, improve the assembly efficiency of the terminal bodies 12 and the insulator 11, and reduce the loss.

### Embodiment 2

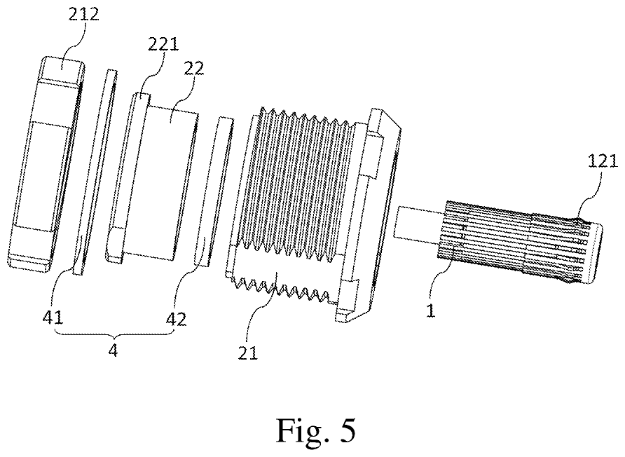

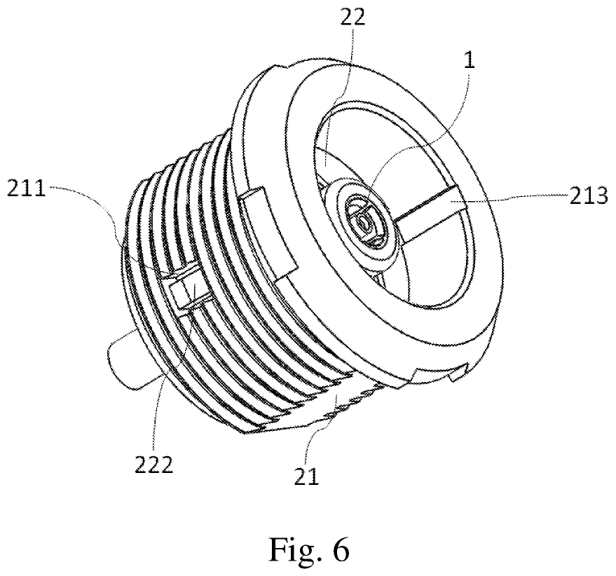

A female socket mechanism provided by the embodiment, as shown in FIG. 4 and FIG. 5, comprising a female socket shell assembly 2 and the terminal assembly 1 of embodiment 1, wherein the terminal assembly 1 is arranged in the female socket shell assembly 2.

In the embodiment, the female socket shell assembly 2 is arranged to fix the terminal assembly 1 and facilitate insertion of the female socket mechanism with the male plug mechanism.

In some embodiments of the present application, the female socket shell assembly 2 comprises a female socket shell 21 and a fixing member 22 arranged in the female socket shell 21, and the terminal assembly 1 is connected with the female socket shell 21 through the fixing member 22.

Specifically, one end of the fixing member 22 is extended into the female socket shell 21 and is connected with the terminal assembly 1, a bending part 221 is formed on the other end, the bending part 221 is connected with one end of the female socket shell 21, and connection strength between the fixing member 22 and the female socket shell 21 is increased by the bending part 221.

In some embodiments of the present application, the end of the female socket shell 21 is stuck in the bending part 221; specifically, the bending part 221 is U-shaped and is stuck with the female socket shell 21 by interference fit, i.e., a size of the female socket shell 21 extending into the bending part 221 is slightly larger than that of an opening of the bending part 221, so that it is difficult to separate the fixing member 22 and the female socket shell 21 under an action of an external force.

In the embodiment, the fixing member 22 is arranged to position and protect the terminal assembly 1; when the fixing member 22 and the female socket shell 21 are connected, the end of the female socket shell 21 is placed in the U-shaped bending part 221 first, and then the female socket shell 21 and the bending part 221 are bonded by ultrasonic welding or adhesive, thus to make the fixing member 22 and the female socket shell 21 form stable connection.

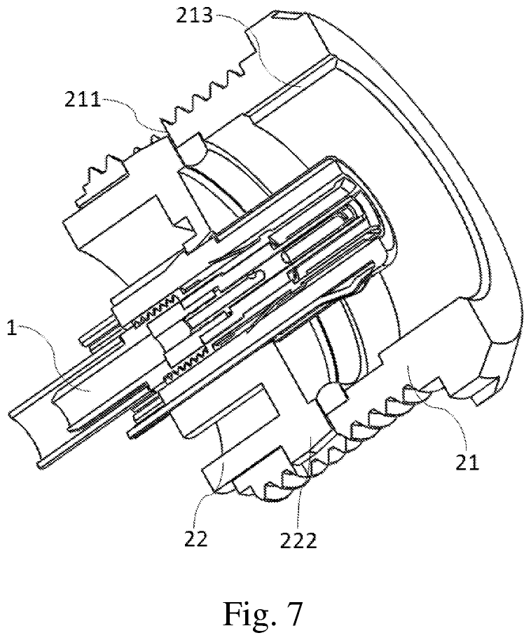

As shown in FIG. 6 and FIG. 7, in some embodiments of the present application, the fixing member 22 is connected with the female socket shell 21 in a buckle form; a clamping block 222 is arranged on the fixing member 22, and a clamping slot 211 matched with the clamping block 222 is formed in the female socket shell 21; or a clamping block 222 is arranged on the female socket shell 21, and a clamping slot 211 matched with the clamping block 222 is formed in the fixing member 22; during assembly, the terminal assembly 1 is inserted into in the fixing member 22, and then the fixing member 22 is extended to a specific position in the female socket shell 21, so that the clamping block 222 is stuck in the clamping slot 211 to realize the stable connection between the fixing member 22 and the female socket shell 21, and thus to realize stable connection between the terminal assembly 1 and the female socket shell 21.

In some embodiments of the present application, the female socket shell 21 is also provided with a protective member 4, the protective member 4 comprises an outer protective ring 41 and an inner protective ring 42, the outer protective ring 41 is arranged on an outer wall of the female socket shell 21, and the inner protective ring 42 is arranged on an inner wall of the female socket shell 21.

When the female socket mechanism is inserted with the male plug mechanism, the male plug mechanism is butted with the inner protective ring 42 to form a sealing structure, thus to prevent rainwater and dust from entering the connector from the connecting position of the two.

Specifically, the outer wall of the female socket shell 21 is provided with an annular bulge, and the outer protective ring 41 is arranged beside the annular bulge; when the female socket shell 21 passes through a wall of an equipment box and is connected with a piece of equipment, the outer protective ring 41 beside the annular bulge is butted with the equipment to form a sealing structure at the connecting position of the two, thus to prevent rainwater and dust from entering the equipment from the connecting position and ensure waterproof and dust-proof effects of the female socket mechanism.

In some embodiments of the present application, the outer wall of the female socket shell 21 is in threaded connection with a nut 212; when the female socket shell 21 passes through the wall of the equipment box, one side of the wall of the equipment box is butted with the annular bulge and the outer protective ring 41 beside the annular bulge, and the other side of the wall of the equipment box is butted with the nut 212 in threaded connection with the outer wall of the female socket shell 21, thus to avoid separation of the female socket shell 21 from the equipment under vibration and other operating conditions.

### Embodiment 3

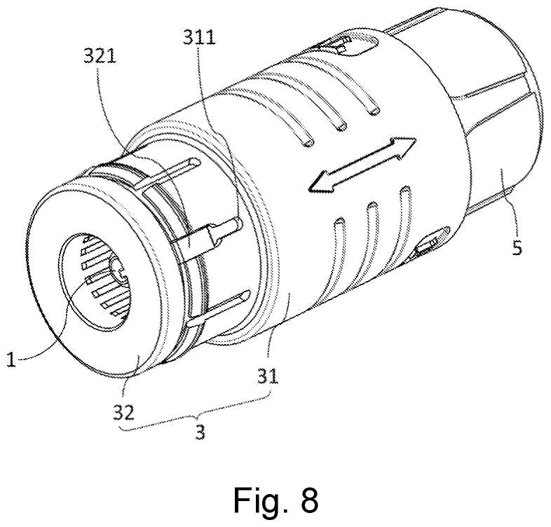

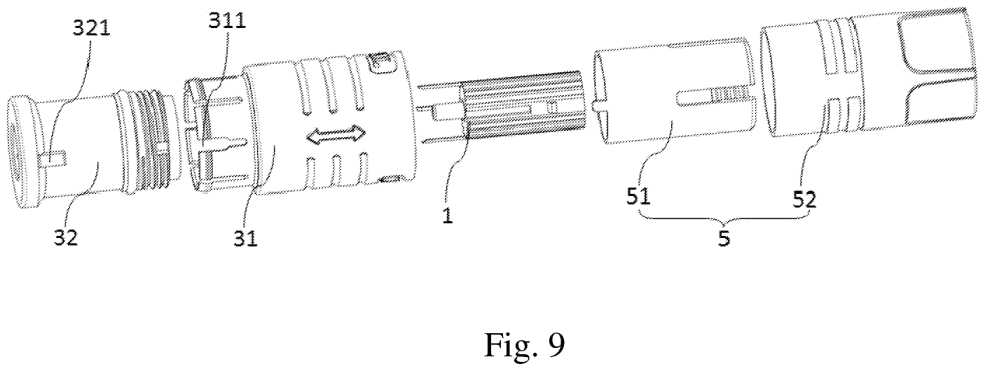

A male plug mechanism provided by the embodiment, as shown in FIG. 8 and FIG. 9, comprising a male plug shell assembly 3 and the terminal assembly 1 of embodiment 1, wherein the terminal assembly 1 is arranged in the male plug shell assembly 3.

In the embodiment, the male plug shell assembly 3 is arranged to protect the terminal assembly 1 and prevent damage to the terminal assembly 1 by an external impact, etc., and the male plug shell assembly 3 can be inserted into the female socket shell assembly 2 to realize insertion of the male plug mechanism into the female socket mechanism.

In some embodiments of the present application, the male plug shell assembly 3 comprises an outer shell 31 and an inner shell 32, the outer shell 31 is sheathed on the inner shell 32, and the terminal assembly 1 is arranged in the inner shell 32.

In the embodiment, the terminal assembly 1 is arranged in the inner shell 32, the terminal assembly 1 is protected by the inner shell 32, and the outer shell 31 is limited, so that the outer shell 31 can be moved on the inner shell 32 along an axis of the male plug mechanism to realize insertion and separation of the male plug mechanism and the female socket mechanism.

In some embodiments of the present application, the inner shell 32 is provided with a guide member 321, and the outer shell 31 has a limiting hole 311 matched with the guide member 321; specifically, the guide member 321 is located in the limiting hole 311; when the outer shell 31 is moved along the axis of the male plug mechanism relative to the inner shell 32, the outer shell 31 is limited by the guide member 321 by limiting a moving direction of the limiting hole 311, thus to prevent the outer shell 31 from rotating relative to the inner shell 32.

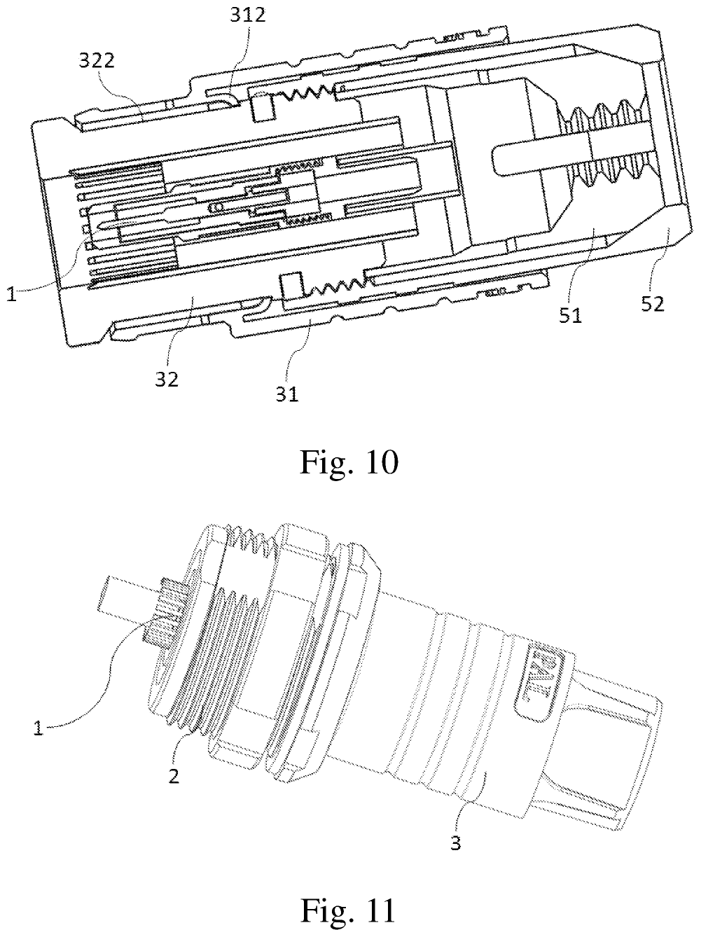

As shown in FIG. 10, in some embodiments of the present application, an inner wall of the outer shell 31 is provided with a limiting member 312, and an outer wall of the inner shell 32 has a limiting groove 322 matched with the limiting member 312, which is used to limit the outer shell 31 and ensure relative positions of the inner shell 32 and the terminal assembly 1 in an axial direction of the male plug mechanism. When the male plug mechanism is inserted into the female socket mechanism, the outer shell 31 is pushed to move along the axial direction of the male plug mechanism relative to the inner shell 32 to ensure that the outer shell 31 and the terminal assembly 1 can be stably connected with the female socket mechanism at the same time, and avoid poor insertion stability caused by too tight or too loose insertion of the external shell 31 and the female socket mechanism.

In some embodiments of the present application, the male plug mechanism also comprises a cable positioning assembly 5, one end of the cable positioning assembly 5 is located in the outer shell 31 and fixedly connected with the inner shell 32.

At present, a cable of the male plug mechanism is welded with the terminal assembly 1, and the cable is easily separated from the terminal assembly 1 under an action of an external force, which affects the use effect of the male plug mechanism; when the embodiment is in use, the cable is connected with the terminal assembly 1 in the inner shell 32 after passing through the cable positioning assembly 5, the cable is clamped by the cable positioning assembly 5, and the cable positioning assembly 5 is fixedly connected with the inner shell 32, which can indirectly improve connection strength between the cable and terminal assembly 1 and prevent the cable from being separated from the terminal assembly 1 when pulled by an external force.

In some embodiments of the present application, the cable positioning assembly 5 comprises a tail cover 52 and a wire clamp 51 arranged in the tail cover 52, the wire clamp 51 is tightened toward an axial direction of the male plug mechanism by an inner wall of one end of the tail cover 52, and the other end of the tail cover 52 is fixedly connected with the inner shell 32.

Specifically, the other end of the tail cover 52 is in threaded connection with the inner shell 32; during connection, the wire clamp 51 is tightened toward the axis of the male plug mechanism by the end of the tail cover 52 with the inner wall tightened, so that the cable inserted into the wire clamp 51 is clamped by the wire clamp 51, thus to realize indirect connection between the cable and the inner shell 32.

In some embodiments of the present application, the end of the tail cover 52 with the inner wall tightened is extended to the outside of the outer shell 31 to facilitate a user to turn the tail cover 52 to realize connection and separation of the tail cover 52 and the inner shell 32, and the wire clamp 51 is tightened toward the axis of the male plug mechanism or loosened to clamp or release the cable.

### Embodiment 4

A circular connector provided by the embodiment, as shown in FIG. 11, comprising the female socket mechanism of embodiment 2 and the male plug mechanism of embodiment 3, wherein the female socket mechanism is inserted with the male plug mechanism.

In some embodiments of the present application, when one end of each terminal body 12 in the female socket mechanism is flat, the end is matched and connected with the bending part 121 or the bulge part 122 of the end of each terminal body 12 in the male plug mechanism; when one end of each terminal body 12 in the female socket mechanism is the bending part 121 or the bulge part 122, the end is matched and connected with a flat end of each terminal body 12 in the male plug mechanism.

In the embodiment, for two terminal bodies 12 in the female socket mechanism and the male plug mechanism, one terminal body 12 has the flat end, and the other terminal body 12 has the bending part 121 or the bulge part 122; when the female socket mechanism is inserted with the male plug mechanism, the flat end is in interference fit with the bending part 121 and the bulge part 122 to ensure signal transmission stability.

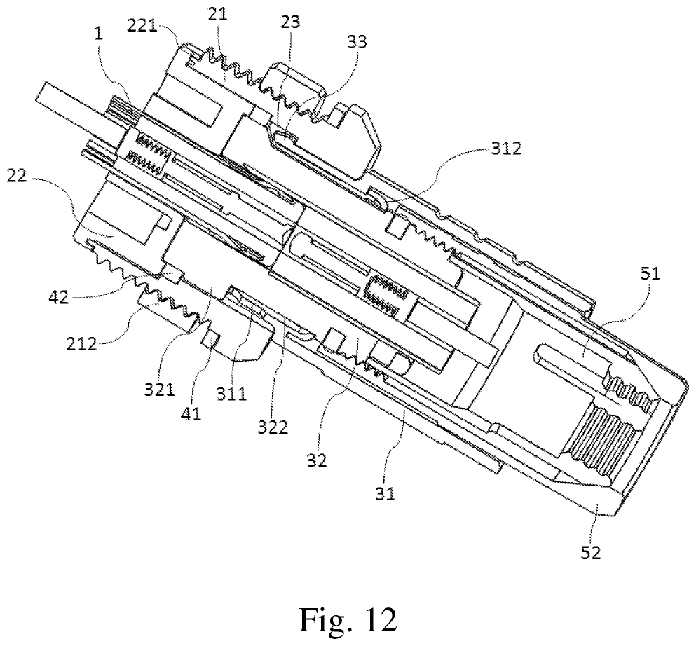

As shown in FIG. 12, in some embodiments of the present application, a positioning groove 23 is formed in the female socket shell assembly 2, and a positioning member 33 matched with the positioning groove 23 is arranged on the male plug shell assembly 3.

Specifically, the positioning groove 23 is formed in the inner wall of the female socket shell 21, and the positioning member 33 is arranged on one end of the outer shell 31 near the female socket shell 21; during insertion of the female socket mechanism and the male plug mechanism, the outer shell 31 is extended into the female socket shell 21 to make the positioning member 33 stuck in the positioning groove 23, thus to avoid too tight or too loose insertion of the female socket mechanism and the male plug mechanism, improve connection stability of the two, ensure that the terminal bodies 12 on the female socket mechanism and the male plug mechanism are in stable contact, and improve the signal transmission stability using the circular connector.

In some embodiments of the present application, a guide groove 213 matched with the guide member 321 is formed in the female socket shell assembly 2.

Specifically, the guide groove 213 is formed in the inner wall of the female socket shell 21; when the male plug mechanism is inserted into the female socket mechanism, the guide member 321 on the inner shell 32 slides in the guide groove 213 to avoid misinsertion when the cylindrical male plug mechanism is inserted into the female socket mechanism, and improve insertion efficiency.

The above only describes preferred specific embodiments of the present invention, but the protection scope of the present invention is not limited thereto. Any change or replacement contemplated easily by those skilled in the art familiar with the technical field within the technical scope disclosed by the present invention shall be covered within the protection scope of the present invention. Therefore, the protection scope of the present invention should be determined by the protection scope of the claims.

What is claimed is:

1. A terminal assembly, characterized by comprising an insulator (11) and terminal bodies (12) arranged on an outer circumferential wall of the insulator (11).

2. The terminal assembly as claimed in claim 1, characterized in that limiting grooves (13) compatible with the terminal bodies (12) are formed in the outer circumferential wall of the insulator (11), and the terminal bodies (12) are located in the limiting grooves (13).

3. The terminal assembly as claimed in claim 2, characterized in that an extension direction of the terminal bodies (12) is parallel to an axis of the insulator (11).

4. The terminal assembly as claimed in claim 2, characterized in that the terminal assembly (1) also comprises a coaxial assembly (14), and the coaxial assembly (14) is arranged in the insulator (11) along the axis of the insulator (11).

5. The terminal assembly as claimed in claim 4, characterized in that one end of each terminal body (12) is flat, or one end of each terminal body (12) is extended along a radial direction of the insulator (11) to form a bending part (121), or a bulge part (122) is formed on one end of each terminal body (12).

6. The terminal assembly as claimed in claim 5, characterized in that at least two terminal bodies (12) are used, and the at least two terminal bodies (12) are arranged on the outer circumferential wall of the insulator (11) at intervals.

7. A female socket mechanism, characterized by comprising a female socket shell assembly (2) and the terminal assembly (1) as claimed in claim 6, wherein the terminal assembly (1) is arranged in the female socket shell assembly (2).

8. The female socket mechanism as claimed in claim 7, characterized in that the female socket shell assembly (2) comprises a female socket shell (21) and a fixing member (22) arranged in the female socket shell (21), and the terminal assembly (1) is connected with the female socket shell (21) through the fixing member (22).

9. The female socket mechanism as claimed in claim 8, characterized in that one end of the fixing member (22) is extended into the female socket shell (21) and is connected with the terminal assembly (1), a bending part (221) is formed on the other end, the bending part (221) is connected with one end of the female socket shell (21), and the end of the female socket shell (21) is stuck in the bending part (221).

10. The female socket mechanism as claimed in claim 9, characterized in that the bending part (221) is U-shaped and is stuck with the end of the female socket shell (21) by interference fit, and the bending part (221) is connected or bonded with the female socket shell (21) by ultrasonic waves.

11. The female socket mechanism as claimed in claim 8, characterized in that the fixing member (22) is connected with the female socket shell (21) in a buckle form; a clamping block (222) is arranged on the fixing member (22), and a clamping slot (211) matched with the clamping block (222) is formed in the female socket shell (21); or a clamping block (222) is arranged on the female socket shell (21), and a clamping slot (211) matched with the clamping block (222) is formed in the fixing member (22).

12. The female socket mechanism as claimed in claim 8, characterized in that the female socket shell (21) is also provided with a protective member (4);
the protective member (4) comprises an outer protective ring (41) and an inner protective ring (42), the outer protective ring (41) is arranged on an outer wall of the female socket shell (21), and the inner protective ring (42) is arranged on an inner wall of the female socket shell (21).

13. A male plug mechanism, characterized by comprising a male plug shell assembly (3) and the terminal assembly (1) as claimed in claim 6, wherein the terminal assembly (1) is arranged in the male plug shell assembly (3).

14. The male plug mechanism as claimed in claim 13, characterized in that the male plug shell assembly (3) comprises an outer shell (31) and an inner shell (32), the outer shell (31) is sheathed on the inner shell (32), and the terminal assembly (1) is arranged in the inner shell (32).

15. The male plug mechanism as claimed in claim 14, characterized in that the inner shell (32) is provided with a guide member (321), and the outer shell (31) has a limiting hole (311) matched with the guide member (321).

16. The male plug mechanism as claimed in claim 14, characterized in that an inner wall of the outer shell (31) is provided with a limiting member (312), and an outer wall of the inner shell (32) has a limiting groove (322) matched with the limiting member (312).

17. The male plug mechanism as claimed in claim 14, characterized in that the male plug mechanism also comprises a cable positioning assembly (5), one end of the cable positioning assembly (5) is located in the outer shell (31) and connected with the inner shell (32).

18. The male plug mechanism as claimed in claim 17, characterized in that the cable positioning assembly (5) comprises a tail cover (52) and a wire clamp (51) arranged in the tail cover (52), one end of the tail cover (52) is extended to the outside of the outer shell (31), the wire clamp (51) is tightened toward an axial direction of the male plug mechanism by an inner wall thereof, and the other end of the tail cover (52) is connected with the inner shell (32).

19. A circular connector, characterized by comprising the female socket mechanism as claimed in claim 12 and a male plug mechanism, wherein the female socket mechanism is compatible with the male plug mechanism;
the male plug mechanism comprising a male plug shell assembly (3) and a terminal assembly (1), wherein the terminal assembly (1) is arranged in the male plug shell assembly (3); the male plug shell assembly (3) comprises an outer shell (31) and an inner shell (32), the outer shell (31) is sheathed on the inner shell (32), and the terminal assembly (1) is arranged in the inner shell (32); the male plug mechanism also comprises a cable positioning assembly (5), one end of the cable positioning assembly (5) is located in the outer shell (31) and connected with the inner shell (32); the cable positioning assembly (5) comprises a tail cover (52) and a wire clamp (51) arranged in the tail cover (52), one end of the tail cover (52) is extended to the outside of the outer shell (31), the wire clamp (51) is tightened toward an axial direction of the male plug mechanism by an inner wall thereof, and the other end of the tail cover (52) is connected with the inner shell (32);
the terminal assembly (1) comprising an insulator (11) and terminal bodies (12) arranged on an outer circumferential wall of the insulator (11); limiting grooves (13) compatible with the terminal bodies (12) are formed in the outer circumferential wall of the insulator (11), and the terminal bodies (12) are located in the limiting grooves (13); the terminal assembly (1) also comprises a coaxial assembly (14), and the coaxial assembly (14) is arranged in the insulator (11) along the axis of the insulator (11); one end of each terminal body (12) is flat, or one end of each terminal body (12) is extended along a radial direction of the insulator (11) to form a bending part (121), or a bulge part (122) is formed on one end of each terminal body (12); at least two terminal bodies (12) are used, and the at least two terminal bodies (12) are arranged on the outer circumferential wall of the insulator (11) at intervals.

20. The circular connector as claimed in claim 19, characterized in that a positioning groove (23) is formed in the female socket shell assembly (2), and a positioning member (33) matched with the positioning groove (23) is arranged on the male plug mechanism.
